(19) United States
(12) Patent Application Publication
(10) Pub. No.: US 2017/0190877 A1
(43) Pub. Date: Jul. 6, 2017

(54) THERMALLY POLYMERIZABLE COMPOSITION, COMBINED SOLUTION FORMED THEREFROM AND USE THEREOF

(71) Applicant: Eternal Materials Co., Ltd., Kaohsiung City (TW)

(72) Inventors: Chi-Yu Huang, Kaohsiung City (TW); Hsiun-Chia Shih, Tainan City (TW)

(21) Appl. No.: 15/246,553

(22) Filed: Aug. 25, 2016

(30) Foreign Application Priority Data
Dec. 31, 2015 (TW) 104144787

(51) Int. Cl. C08K 5/523; C08K 5/14

(52) U.S. Cl. CPC C08K 5/523; C08K 5/14

(57) ABSTRACT

The present invention provides a thermally polymerizable composition, which comprises (a) a monomer; (b) a thermal initiator, (c) a plasticizer, wherein the monomer comprises a mono-functional acrylate monomer, a multi-functional acrylate monomer, or a mixture thereof. The present invention also provides a combined solution formed from said thermally polymerizable composition via solvent-free thermal polymerization. The polymer may be used for adhering, coating or sealing.

### BACKGROUND OF THE INVENTION

1. Field of the Invention

The present invention generally relates to a thermally polymerizable composition and a combined solution formed therefrom which is particularly involved in adhering, coating or sealing.

2. Description of the Prior Art

With the rapid development of the information technology, electronic gadgets such as a cellphone, personal digital assistant, tablet and laptop, have become indispensable tools in our daily life. To provide a more convenient and user-friendly operation interface, a sensing system laminated and integrated on a display screen is manufactured. For instance, a touchscreen comprising a touch panel (TP) module laminated on a liquid crystal module (LCM) allowing users to operate device directly by touching the screen.

To obtain a better visual effect and slimmer outlook of the device, a variety of lamination and adhering technologies have been proposed to manufacture touchscreens. Full lamination technology is one of the highly adopted technologies and has occupied an important position in the industry. It enables a very compact lamination of the display panel and touch panel, and moreover, provides a better image quality. The space between two full laminated panels is completely filled with an adhesive layer and therefore any air gap formed between the two panels is avoided. In this configuration, the light emitting from the display panel is more likely to transmit through the laminated stack without been refracted at the interface of materials with different refraction indexes, such as glasses (refraction index is 1.5), adhesive and air (refraction index is 1.0), which may cause lower brightness or multiple images. Full lamination technology dose not only provide a higher quality image but also provide stronger durability.

FIG. 1 is a schematic diagram illustrating the stacked layers of a touchscreen adopting the full lamination technology. FIG. 2 is a schematic cross-sectional diagram of FIG. 1. As shown in FIG. 1 and FIG. 2, a touchscreen 1 comprises a touch panel 10, an adhesive layer 12, and a display panel 20. The adhesive layer 12 comprises a liquid optically clear adhesive (LOCA) 14 and a photo-curable frame glue 16.

The touch panel 10 is adhered onto the display panel 20 mainly by the LOCA 14 and the frame glue 16. The LOCA 14 may preferably have low viscosity and adequate leveling property to be able to flow throughout the panels evenly during the laminating process.

In comparison to LOCA 14, the frame glue 16 usually has high viscosity. It is used to prevent the LOCA 14 from overflowing during the adhering process, which is a serious issue especially for a large panel. Meanwhile, the frame glue 16 may be applied along the top of a gap 22 between the liquid crystal panel and the frame to serve as a sealant, preventing any contaminating substance from entering into the liquid crystal panel through the gap 22.

Typically, during the adhering process, the frame glue 16 is coated or applied by injecting printing and simultaneously cured along the perimeter area of the display panel 20, forming a frame with a predetermined height (or thickness). The cured frame glue 16 and the underneath display panel 20 forms a recess structure for receiving the LOCA 14. Latterly, the LOCA 14 is applied along a double-Y shape or an I-shape gluing path within the recess. Afterward, the upper panel (touch panel) is pressed and laminated onto the lower panel (display panel) in a manner of keeping a uniform spacing formed there between which is determined by the height of the cured frame glue 16.

The glue roughly may be classified into two types according to the polymer comprised in the composition. Rubber-based glue is developed and utilized by the industry earlier than acrylic-based glue. The composition of the rubber-based glue comprises elastic polymers, such as polyisoprene, polybutadiene or polyurethane. Rubber-based glue is known for its anti-yellowing property, elasticity, good adhering ability and high refraction index. However, the application of rubber-based glue has been limited for several reasons. First, the cost is higher since the raw material used to synthesis rubber-based glue is expensive. Second, it tends to leave residue during rework, resulting in low yield.

Acrylic-based glue is the other type glue which comprises polymers such as polyacrylate. These important characteristics such as transparency for visible-light, adhering ability and anti-yellowing property also conform to the requirement. Advantageously, the cost of using acrylic-based glue is lower, for its raw material is cheaper and it could be removed completely, and not leave residue during rework. Therefore, acrylic-based glue has been adopted widely and played an important role in the industry.

Conventionally, in the process of preparing the glue used in panel lamination, for example, the LOCA 14 and its corresponding frame glue 16, a glue used as LOCA 14 having specific viscosity or dielectric constant is prepared firstly according to various specifications of products and glue dispensing equipment. Afterward, another glue used as the corresponding frame glue 16 is prepared respectively in additional synthesis steps. To guarantee the compatibility of the LOCA 14 and the corresponding frame glue 16, the process of preparing the corresponding frame glue 16 aforesaid is usually complicated and not cost effective.

In the light of the above, an improved method with less cost and simplified steps for preparing a LOCA and its matching frame glue is needed. In the present invention, a simplified, cost effective and environmentally-friendly method to prepare a LOCA and its matching frame glue is provided after a serious of extensive experiments and in-depth research. It is disclosed in the present invention that by applying a solvent-free thermal polymerization method, an adhering composition may be obtained in a spectrum of viscosity. By the method, both LOCA and its matching frame glue may be obtained in the same process conveniently and cost effectively.

### SUMMARY OF THE INVENTION

One objective of the present invention is to provide a thermally polymerizable composition comprising:
(a) a monomer;
(b) a thermal initiator;
(c) a plasticizer, wherein the monomer of the component (a) comprises mono-functional acrylate monomer, multi-functional acrylate monomer, or a mixture thereof.

Another objective of the present invention is to provide a combined solution obtained by a solvent-free thermal polymerization of the thermally polymerizable composition described above.

Still another objective of the present invention is to provide an adhering composition comprising the combined solution described above.

The combined solution described above is obtained via a solvent-free thermal polymerization according to the present invention, and may be further used to prepare an adhering composition for adhering, coating or sealing application.

This present invention has significant advantages and benefits over the prior art. By the technological scheme of the present invention as illustrated above, a LOCA and its matching frame glue with different viscosities may be obtained respectively from the same composition, in other words, using the same raw material. At least the advantages as following may be achieved by the present invention:

(1) The process is simplified and the production cost is reduced.

(2) The capability of the LOCA and its matching frame glue could avoid a visible interface between them when the frame glue is used during the adhering process of the touch panel manufacturing process to prevent the LOCA from overflowing.

(3) The present invention may be applicable for optical devices, for example, replacing the OCA tape used in the conventional manufacturing process of the optical devices to simplify the process and improve the yield.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating the stacked layers of a touchscreen adopting the full lamination technology.

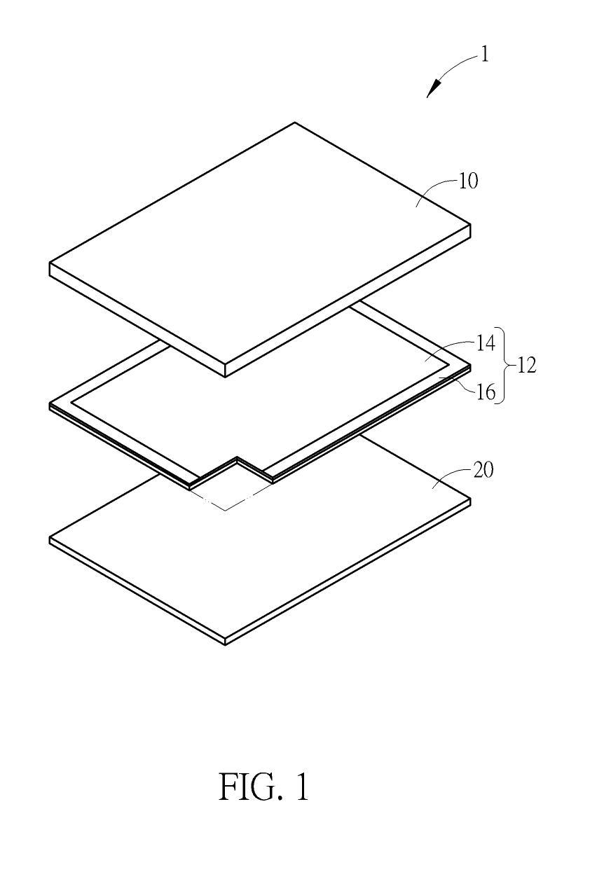

FIG. 2 is a schematic cross-sectional diagram of FIG. 1

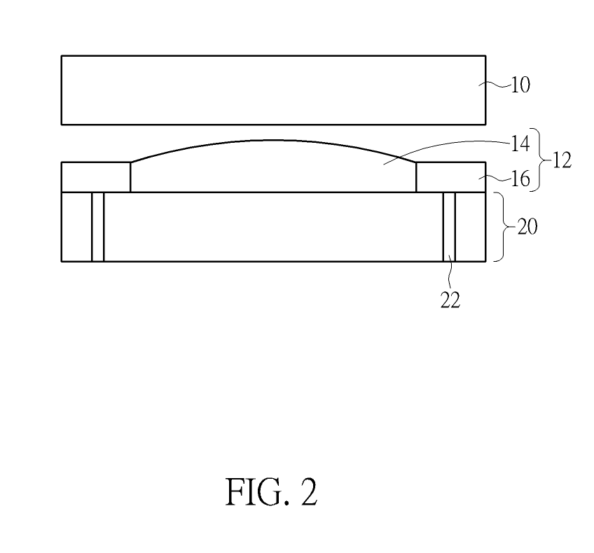

### DETAILED DESCRIPTION

The following detailed description is not to be taken in a limiting sense, and the scope of the present invention is defined by the appended claims, along with the full scope of equivalents to which such claims are entitled. Other embodiments may be utilized and that structural or composition changes may be made without departing from the spirit and scope of the present invention.

Some specific embodiments of the present invention are described in the following. However, the present invention can be implemented in various different manners without departing from the scope of the present invention, and the following detailed description is not to be taken in a limiting sense. Additionally, unless otherwise states, “a (n)”, “the” and similar terms used in the specification (especially in the appending claims) should be understood to include singular and plural forms.

One objective of the present invention is to provide a thermally polymerizable composition comprising:
(a) a monomer;
(b) a thermal initiator;
(c) a plasticizer, wherein the monomer comprises mono-functional acrylate monomer, multi-functional acrylate monomer, or a mixture thereof.

According to one embodiment of the present invention, the temperature of the boiling point of the plasticizer of the component (c) is higher than the activating temperature of the thermal initiator of the component (b).

According to one embodiment of the present invention, the monomer of the component (a) of the thermally polymerizable composition may comprise acrylate monomer such as a mono-functional acrylate monomer, a multi-functional acrylate monomer, or a mixture thereof.

According to one embodiment of the present invention, the mono-functional acrylate monomer as mentioned may be selected from a group comprising methyl methacrylate (MMA), butyl methacrylate, 2-phenoxy ethyl acrylate, ethoxylated 2-phenoxy ethyl acrylate, 2-(2-ethoxyethoxy)ethyl acrylate, cyclic trimethylolpropane formal acrylate, β-carboxyethyl acrylate, 3,3,5-trimethyl cyclohexane acrylate, Ortho-phenyl phenoxy ethyl acrylate, cumyl phenoxyl ethyl acrylate, lauryl methacrylate, isooctyl acrylate, stearyl methacrylate, isodecyl acrylate, isoborny methacrylate, benzyl acrylate, 2-hydroxyethyl metharcrylate phosphate, caprolactone acrylate, hydroxyethyl acrylate (HEA), 2-hydroxyethyl methacrylate (HEMA), and a mixture thereof.

According to one embodiment of the present invention, the multi-functional acrylate monomer as mentioned may be selected from a group comprising hydroxypivalyl hydroxypivalate diacrylate, 1,6-hexanediol diacrylate, ethoxylated 1,6-hexanediol diacrylate, dipropylene glycol diacrylate, tricyclodecane dimethanol diacrylate, ethoxylated dipropylene glycol diacrylate, neopentyl glycol diacrylate, propoxylated neopentyl glycol diacrylate, ethoxylated bisphenol-A dimethacrylate, 2-methyl-1,3-propanediol diacrylate, ethoxylated 2-methyl-1,3-propanediol diacrylate, 2-butyl-2-ethyl-1,3-propanediol diacrylate, ethylene glycol dimethacrylate (EGDMA), diethylene glycol dimethacrylate, tris(2-hydroxy ethyl)isocyanurate triacrylate, pentaerythritol triacrylate, ethoxylated trimethylolpropane triacrylate, propoxylated trimethylolpropane triacrylate, trimethylolpropane trimethacrylate, pentaerythritol tetraacrylate, ethoxylated pentaerythritol tetraacrylate, ditrimethylolpropane tetraacrylate, propoxylated pentaerythritol tetraacrylate, dipentaerythritol hexaacrylate, tripropylene glycol dimethacrylate, 1,4-butanediol dimethacrylate, 1,6-hexanediol dimethacrylate, allylatedcyclohexyl dimethacrylate, isocyanurate dimethacrylate, ethoxylated trimethylolpropane trimethacrylate, propoxylated glycerol trimethacrylate, tris(acryloxyethyl)isocyanurate, trimethylolpropane triacrylate, and a mixture thereof.

According to one embodiment of the present invention, the monomer of the component (a) of the thermally polymerizable composition may be in the form of glue with a specific viscosity smaller than 10000 cps at the room temperature. Preferably, the viscosity of the monomer of the component (a) is smaller than 1000 cps or, best of all, smaller than 100 cps.

According to one embodiment of the present invention, the monomer of the component (a) is present in the thermally polymerizable composition in an amount of 5% to 69.99% by weight based on the total weight of the thermally polymerizable composition, and preferably, in an amount of 10% to 59.99%.

According to one embodiment of the present invention, the monomer of the component (a) of the thermally polymerizable composition comprises a caprolactone acrylate.

Optionally, according to one embodiment of the present invention, the monomer of the content (a) of the thermally polymerizable composition may further comprise a vinyl monomer with a restriction of not including acrylate monomers. The vinyl monomer as mentioned may comprise, but is not limited to, a styrene monomer, a N-vinyl monomer, or a mixture thereof. It should be noticed that the said styrene monomer includes styrene and its derivatives.

According to one embodiment of the present invention, the styrene monomer of the optionally vinyl monomer as mentioned previously may be selected from a group comprising styrene, 4-chloro-α-methylstyrene, α-methylstyrene, 4-methylstyrene, α-ethylstyrene, 4-ethylstyrene, 3-methylstyrene, 4-propylstyrene, 4-cyclohexylstyrene, divinylbenzene, 3-methoxy-α-nitrostyrene, nitrostyrene, fluorostyrene, bromostyrene, chlorostyrene, chloro-methylstyrene, aminostyrene, 4-methoxystyrene, 4-ethoxystyrene, hydroxystyrene, acetoxystyrene, 1-vinylnaphthalene, 2-vinylnaphthalene, 4-dodecylstyrene, 2-ethyl-4-benzylstyrene, 4-phenylbutylstyrene, and a mixture thereof. Preferably, the styrene monomer is selected from a group with low polarity which may comprise styrene, α-methylstyrene, 4-methylstyrene, α-ethylstyrene, 4-ethylstyrene, 3-methylstyrene, 4-propylstyrene, 4-dodecylstyrene, 4-methoxystyrene, 4-ethoxystyrene, and a mixture thereof. According to a preferred embodiment, styrene is selected to be optionally vinyl monomer comprised in the content (a) of the thermally polymerizable composition.

According to one embodiment of the present invention, the N-vinyl monomer of the optionally vinyl monomer as mentioned previously may be selected from a group comprising N-vinylcarbazole, N-vinylindole derivatives, N-vinylpyrrolidone, N-vinylcaprolactam, N-vinylformamide, N-vinylacetoamide derivatives, N-vinyl(na)phthalimides, N-vinylimidazolium salts, N-vinyltriazoles, and a mixture thereof.

According to one embodiment of the present invention, when the monomer of the component (a) of the thermally polymerizable composition further comprises the optionally vinyl monomer, there is no particular restriction about the order of supplying the acrylate monomer and the vinyl monomer into the reactor. The acrylate monomer and the vinyl monomer may be supplied together at the same time into the reactor, or supplied separately.

The thermal initiator of the component (b) of the thermally polymerizable composition may be a thermally decomposing initiator, but not limited thereto. According to one embodiment of the present invention, the thermal initiator of the component (b) as mentioned above may be selected from a group comprising benzoyl peroxide, cumyl hydroperoxide, dicumyl peroxide, tert-Butyl hydroperoxide, tert-Butyl monoperoxymaleate, acetyl peroxide, dilauroyl peroxide, a mixture of at least one of the said peroxide and a cobalt-containing compound, AIBN, and a mixture thereof.

There is no particular limitation about amount of the thermal initiator of the component (b) comprised in the thermally polymerizable composition. It is adjustable based on the amount and species of the monomer involved in the polymerization, and the degree of polymerization of the monomer to be obtained. According to one embodiment of the present invention, the thermal initiator of the component (b) of the thermally polymerizable composition is present in an amount of 0.001% to 5% by weight based on the total weight of the thermally polymerizable composition. Preferably, a thermally decomposing initiator with a thermally decomposing temperature (activating temperature) ranging from −10° C. to 200° C. is selected.

According to one embodiment of the present invention, the thermal initiator is dilauroyl peroxide with a decomposing temperature between 70° C. to 80° C.

The plasticizer of the component (c) of the thermally polymerizable composition of the present invention is inert, thermal stable and sparingly volatile, and has a boiling temperature higher than the activating temperature of the thermal initiator to initiate the polymerization. The preferred condition is that the boiling point of the plasticizer and the thermal cleavage temperature of the plasticizer are both higher than the initial temperature of the polymerization initiator in order to avoid the occurrence of boiling plasticizer or cleavage. One feature of the present invention is that the plasticizer of the component (c) also serves as the intermediate for the polymerization to carry out. Advantageously, the substitution of convention organic solvent with the plasticizer is able to avoid the situation that the conventional organic solvent would vaporize and be lost easily during the polymerization. Furthermore, additional steps of the conventional method to remove and recycle the organic solvent from the resulting product could be omitted. Comparing to the conventional method using organic solvent, the solvent-free polymerization of the present invention is more environmentally-friendly and cost effective.

The amount of the plasticizer of the component (c) of the thermally polymerizable composition is sufficient to mix the monomer and the thermal initiator evenly, promoting the polymerization reaction. Problems arising from uneven heating due to locally high viscosity could be avoided too. According to one embodiment of the present invention, the plasticizer of the component (c) of the thermally polymerizable composition is present in an amount of 30% to 95% by weight based on the total weight of the thermally polymerizable composition. Preferably, the amount of the plasticizer of the component (c) is between 40% and 90%.

According to one embodiment of the present invention, the plasticizer of the component (c) of the thermally polymerizable composition may be selected from a group comprising phthalic acid ester, aliphatic binary acid ester, phosphate ester, benzene polycarboxylic acid ester, fluorene-containing diester, alkyl sulfonic ester, polyol ester, epoxide, and a mixture thereof. According to one preferred embodiment, the selected plasticizer may comprise phthalic acid ester, phosphate ester, or a mixture thereof.

The phthalic acid ester as mentioned may be selected from a group comprising phthalates (C6H4(COOCH3)2), di-ethyl phthalate (C6H4(COOC2H5)2), di-allyl phthalate (C6H4(COOCH2CH═CH2)2), di-propyl phtalate (C6H4(COOCH2CH2CH3)2), di-butyl phtalate (C6H4[COO(CH2)3CH3]2), di-iso-butyl phtalate (C6H4[COOCH2CH(CH3)2]2), di-N-pentyl phthalate (C6H4[COO(CH2)4CH3]2), di-cyclohexyl phthalate (C6H4(COOC6H11)2), benzyl butyl phthalate (BBP) (CH3(CH2)3OOCC6H4COOCH2C6H5), bis(2-ethylhexyl) phthalate (C6H4[COO(CH2)5CH3]2), di-iso-heptyl phthalate (C6H4[COO(CH2)4CH(CH3)2]2), bis(2-ethylhexyl)ortho-phthalate (C6H4[COOCH2CH(C2H5)(CH2)3CH3]2), di-octyl phthalate (C6H4[COO(CH2)7CH3]2), di-iso-octyl phthalate (C6H4[COO(CH2)5CH(CH3)2]2),di-iso-nonyl phthalate (C6H4[COO(CH2)6CH(CH3)2]2), di-iso-decyl phthalate (C6H4[COO(CH2)7CH(CH3)2]2), di-undecyl phthalate (C6H4[COO(CH2)10CH3]2), and a mixture thereof. Preferably, the said phthalic acid ester may be selected from a group comprising phthalates, di-ethyl phthalate, di-allyl phthalate, benzyl butyl phthalate, di-iso-nonyl phthalate, and a mixture thereof.

Preferably, the phosphate ester as mentioned may be selected from a group comprising triphenyl phosphate (TPP), tricresyl phosphate (TCP), tri(isopropylphenyl) phosphate (IPPP), cresyl diphenyl phosphate (CDP), tetraphenyl resorcinol diphosphate, tetraphenyl 4,4′-(propane-2,2-diyl)bis(4,1-phenylene) diphosphate (BDP), and a mixture thereof.

According to one preferred embodiment, the plasticizer of the component (c) of the thermally polymerizable composition is tetraphenyl 4,4′-(propane-2,2-diyl)bis(4,1-phenylene) diphosphate (BDP) with the formula as shown underneath, wherein the refraction index of BDP is around 1.6.

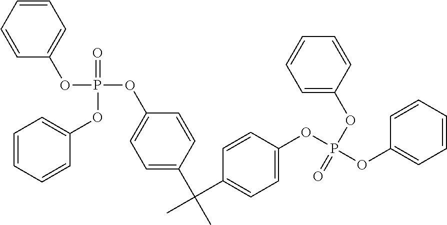 [SMILES: CC(C)(c1ccc(OP(=O)(Oc2ccccc2)Oc2ccccc2)cc1)c1ccc(OP(=O)(Oc2ccccc2)Oc2ccccc2)cc1]

Another objective of the present invention is to provide a combined solution, which is formed from the thermally polymerizable composition via a method of solvent-free thermal polymerization.

According to one embodiment of the present invention, the method of solvent-free thermal polymerization may comprise the following steps:

(1) providing a first solution by mixing a monomer and a plasticizer in a reactor and heating the mixture to a pre-determined temperature, wherein the step is carried out in a deoxygenated environment;

(2) mixing the first solution and a thermal initiator comprised in a second solution in the reactor in a deoxygenated environment to form the thermally polymerizable composition, wherein the second solution is supplied into the reactor in a drop-by drop manner;

(3) initiating a thermal polymerization of the thermally polymerizable composition by the thermal initiator and the combined solution is obtained therefrom.

The monomer, thermal initiator and plasticizer used in the method of solvent-free thermal polymerization may be referred to as described previously, and will not be narrated herein.

The pre-determined temperature in step (1) depends on the monomer and the associative thermal initiator selected. According to one embodiment of the invention, the pre-determined temperature is between 80° C. and 300° C. Preferably, the plasticizer in step (1) is present in an amount of not less than 40% by weight based on the total weight of the first solution.

The second solution in step (2) may be prepared in advanced by dissolving the thermal initiator in another portion of the monomer or the plasticizer of step (1), for the convenience of adding into the reactor drop-by drop. The thermal initiator of the second solution may be a type of initiator which may decompose and form free radicals (primarily free radical) to initiate the polymerization. For example, but not limited thereto, the thermal initiator may be any suitable thermally cleaved initiator known by those skilled in the art, such as peroxides or azo compounds. According to another embodiment of the present invention, another type of initiator which forms free radicals via redox reaction may also be used to initiator the polymerization.

In step (3), the thermal polymerization of the monomer comprised in the thermally polymerizable composition is initiated by the thermal initiator. A polymer is formed and the combined solution comprising the polymer and the plasticizer is obtained therefrom.

According to one embodiment of the present invention, after the thermal polymerization in step (3), the plasticizer comprised in the combined solution is present in an amount of not less than 30% by weight based on the total weight of the combined solution.

According to one embodiment of the present invention, the viscosity of the combined solution may range from 1,000 cps to 2,000,000 cps, preferably, from 1,500 cps to 250,000 cps.

Still another objective of the present invention is to provide an adhering composition which comprises the combined solution obtained from the thermal polymerization of the thermally polymerizable composition as mentioned previously. More particularly, the adhering composition provided by the invention comprises:
(i) the combined solution;
(ii) a mono-functional monomer, a multi-functional monomer, or a mixture thereof;
(iii) a photo-initiator; and
(iv) a second plasticizer.

According to one embodiment of the present invention, the combined solution of the component (i) of the adhering composition is provided from the solvent-free thermal polymerization of the thermally polymerizable composition as mentioned previously, and comprises the plasticizer and the polymer. The combined solution is present in an amount of 20% to 90% by weight based on the total weight of the adhering composition. Preferably, it is present in an amount of 40% to 85%, and more preferably, of 50% to 80%.

According to one embodiment of the present invention, the monomer of the component (ii) of the adhering composition is present in a proper amount to dilute the viscosity of the adhering composition to a various pre-determined viscosities particularly for different products, allowing a wide spectrum of application of the adhering composition.

According to one embodiment of the present invention, the mono-functional monomer or the multi-functional monomer of the component (ii) of the adhering composition may be selected from a group comprising 2 phenoxy ethyl acrylate, lauryl methacrylate, isodecyl acrylate, isoborny methacrylate, trimethylolpropane trimethacrylate, pentaerythritol tetraacrylate, ethoxylated trimethylol propane trimeth acrylate, propoxylated glycerol trimethacrylate, trimethylolpropane triacrylate, and a mixture thereof.

Commercially available mono-functional monomer or multi-functional monomer applicable for the present invention may comprise the following products manufactured by Eternal Material Corporation with the trade designation of EM223, EM328, EM2308, EM231, EM219, EM90, EM70, EM235, EM2381, EM2382, EM2383, EM2384, EM2385, EM2386, EM2387, EM331, EM3380, EM241, EM2411, EM242, EM2421 or EM265.

According to one embodiment of the present invention, the mono-functional monomer or multi-functional monomer of the component (ii) of the adhering composition is present in the adhering composition in an amount of 5% to 80% by weight based on the total weight of the adhering composition, and preferably in an amount of 5% to 40%, and more preferably in an amount of 5% to 30%.

The photo-initiator of the component (iii) of the adhering composition is not restricted to any particular species only if it would generate free radicals after illumination and initiate a free radical polymerization reaction of the adhering composition. The photo-initiator of the component (iii) of the adhering composition is present in an adjustable amount according to the amount and the species of the monomer of the component (ii) and of the polymer comprised in the combined solution of the component (i). According to the present invention, the photo-initiator of the component (iii) of the adhering composition is present in an amount of 0.1% to 5% by weight based on the total weight of the adhering composition, preferably, present in an amount of 0.5% to 3%.

According to one embodiment of the present invention, the photo-initiator of the component (iii) of the adhering composition may comprise, but is not limited to, benzophenone, benzoin, 2-hydroxy-2-methyl-1-phenyl-propan-1-one, 2,2-dimethoxy-1,2-diphenylethan-1-one, 1-hydroxy cyclohexyl phenyl ketone, 2,4,6-trimethylbenzoyl diphenyl phosphine oxide, or the mixture thereof. According to one preferred embodiment, the photo-initiator comprises benzophenone, 1-hydroxy cyclohexyl phenyl ketone or 2,4,6-trimethylbenzoyl diphenyl phosphine oxide.

The second plasticizer of the component (iv) of the adhering composition may be any suitable plasticizer known by those skilled in the art. The second plasticizer of the component (iv) of the adhering composition may be identical to or different from the plasticizer of the component (c) of the thermally polymerizable composition mentioned in the previous paragraph. According to one embodiment of the present invention, the second plasticizer of the component (iv) may be selected from a group comprising phthalic acid ester, aliphatic binary acid ester, phosphate ester, benzene polycarboxylic acid ester, alkyl sulfonic ester, polyol ester, epoxide, and the mixture thereof. According to one preferred embodiment, the second plasticizer comprises phthalic acid ester, phosphate ester, and the mixture thereof.

According to one embodiment of the present invention, the amount of the second plasticizer of the component (iv) of the adhering composition is present in an amount of 1% to 60% by weight based on the total weight of the adhering composition, preferably, in an amount of 5% to 50%, and more preferably, in an amount of 10% to 40%.

One of the applications of the adhering composition is to be the LOCA used in the lamination process of the touch panel and the display panel. In this case, the plasticizer comprised in the combined solution of the component (i) and the second plasticizer of the component (iv) of the adhering composition may be able to adjust the refraction index of the LOCA. According to one embodiment of the present invention, the plasticizer and second plasticizer selected may have refraction indexes greater than 1.48 respectively, to make the refraction index of the cured adhering composition closer to the refraction index of glass of the panels. Furthermore, the plasticizer and second plasticizer may also improve the flexibility of the cured adhering composition.

The adhering composition may further comprise additional additives known by those skilled in the art, such as, but not limited to, synergist, sensitizer, coupling agent, wetting agent, thickening agent, foam suppressant, chain transfer agent, anti-yellowing agent, thixotropic agent.

The adhering composition, or a glue comprising the polymer formed from the solvent-free thermal polymerization of the thermally polymerizable composition is applicable to be the adhering, coating or sealing material. Generally, the adhering composition may be applied to be, but not limited to, a LOCA, a pressure sensitive adhesive (PSA), or a stripper. Comparing to the conventional process, the method of solvent-free thermal polymerization according to the present invention may be used to form an adhering composition or a glue with a viscosity adjustable in a wide range depending on the specification of different applications through a simplified and cost-effective process.

According to the present invention, the adhering composition may be applied onto a surface of a device to adhere another device by any well-known method in the art. Afterward, the adhering composition may be cured by the irradiation of an energy ray, such as UV ray. For example, the adhering composition may be used to laminate a glass substrate or a cover lens onto a sensing ITO film or ITO glass of a touch panel. Another example of the application of the adhering composition is to laminate a sensing ITO film or a sensing ITO glass with another sensing ITO film or another sensing ITO glass. Furthermore, the adhering composition may be used to laminate a touch panel with a LCD panel.

### EXAMPLES

The present invention is further illustrated with the following examples. It should be understood that the following examples are merely for the purpose of exemplarily illustrating the principle and technical features of the present invention, but are not intended to limit the present invention. Therefore, any modifications or variations that made by those skilled in the art to the above examples will be encompassed in the disclosure of the specification and the scope of the appended claims.

Three groups of examples, a1 to a8, b1 to b12 and c1 to c4, are carried out to illustrate the method of preparing thermally polymerizable composition, and forming the combined solution from the thermally polymerizable composition via a method of the solvent-free thermal polymerization. In each group of examples, the thermally polymerizable composition of each example is prepared comprising components selected from list 1 in various proportions as a first solution and a second solution. The detailed proportions (amount) of each component are as set forth in table 1 to table 3. Latterly, the first solution and the second solution are mixed in a reactor at a pre-determined temperature to initiate the solvent-free thermal polymerization. A combined solution is obtained after the solvent-free thermal polymerization, and the viscosity of the combined solution is measured by using, for example, Brookfield LV viscometer at temperature of 25° C. Detailed process steps are illustrated in the following description.

List 1 below shows the commercially available products which are used in the following examples and their suppliers thereof. Components a, b and c are thermally polymerizable acrylate monomers. components d, f, and g are plasticizers. Composition i is a thermal initiator.

List 1

| component | Product Name and Supplier |
|---|---|
| a | SR504 (ethoxylated(4) nonyl phenol |
| | acrylate) by Sartomer. |
| b | EM214 (tetrahydrofurfuryl acrylate) by |
| | Eternal Materials Co.. |
| c | SR495B (caprolactone acrylate) by |
| | Sartomer. |
| d | Tricresyl phosphate(TCP) from Go Yen |
| | Chemical Industrial Co.. |
| f | Tetraphenyl resorcinol |
| | bis(diphenylphosphate) from Go Yen |
| | Chemical Industrial Co.. |
| g | Bisphenol-A bis(diphenyl phosphate) from |
| | GoYen Chemical Industrial Co.. |
| i | Lauroyl peroxide from Aldrich. |

### Examples a1-a8

The amount and proportion of each component comprised in the composition of examples a1 to a8 are as set forth in table 1. According to the present invention, the method to prepare a thermally polymerizable composition and to obtain a combined solution from the thermally polymerizable composition via a solvent-free polymerization process may, taking example a1 for illustration, comprise these steps:

(1) Preparing the first solution: mixing 200 g component a (monomer) and 250 g component d (plasticizer) in a reactor completely to become a homogeneous, or at least non-heterogeneous, mixture. Subsequently, deoxygenating the mixture and heating it to around 120° C.

(2) Preparing the second solution: mixing 50 g component a (monomer) and 0.2 g component i (thermal initiator) completely and deoxygenating the mixture.

(3) Supplying the second solution into the reactor slowly, for example, in a drop by drop manner. The thermal polymerization reaction of the component a (monomer) is initiated to form a resulting polymer. The speed of adding the second solution may be well controlled at a speed of 0.1 to 5 ml per minute. The reaction may last for additional 0.5 to 4 hours before be terminated after all of the second solution is supplied into the reactor. Consequently, after the thermal polymerization reaction, a combined solution comprising the resulting polymer of the component a (monomer) and the component d (plasticizer) is obtained therefrom.

Examples a2 to a8 are carried out respectively following steps (1), step (2) and step (3) as illustrated above. Viscosity of the resulting combined solution of each example is measured and also shown in table 1 accordingly.

TABLE 1

| | | | | | | | Components of Second | | | | Viscosity |
|---|---|---|---|---|---|---|---|---|---|---|---|
| | Components of First solution | | | | | | solution | | | | of combined |
| | (unit: gram) | | | | | | (unit: gram) | | | | solution |
| | a | b | c | d | f | g | a | b | c | i | (unit: cps) |
| a1 | 200 | | | 250 | | | 50 | | | 0.2 | 1700 |
| a2 | 200 | | | 250 | | | 50 | | | 0.3 | 3150 |
| a3 | 200 | | | 250 | | | 50 | | | 0.5 | 5500 |
| a4 | 200 | | | | 250 | | 50 | | | 0.3 | 1520000 |
| a5 | 200 | | | | | 250 | 50 | | | 0.3 | 44000 |
| a6 | 250 | | | | | 300 | 50 | | | 0.4 | 72000 |
| a7 | 500 | | | | | 600 | 100 | | | 0.8 | 37000 |
| a8 | | 300 | | 300 | | | | 100 | | 0.06 | 18000 |

According to examples a1, a2 and a3, it may be concluded that viscosity of the combined solution would be greater with higher concentration of the thermal initiator (component i). Moreover, according to examples a1 and a8 which comprise different monomers (component a, b or d), the method of the present invention is also applicable to compositions comprising different monomers. According to examples a2, a4 and a5, the method of the present invention is also applicable to compositions comprising different plasticizers (component d, f or g). Furthermore, according to examples a6 and a7, the method of the present invention is also applicable while the composition is proportionally scaled.

### Examples b1-b12

Examples b1 to b12 are another group of examples comprising component c (monomer), component f (plasticizer) and component i (thermal initiator).

Examples b1 to b12 may be carried out following the process of steps (1), step (2) and step (3) aforesaid, but differently, the amount and proportion of the components comprised in the first solutions and the second solutions of examples b1 to b12 are as set forth in table 2. Viscosities of the resulting combined solutions of examples b1 to b12 are measured and also shown in table 2 accordingly.

TABLE 2

| | Components of First | | Components of | | Viscosity |
|---|---|---|---|---|---|
| | solution | | Second solution | | of combined |
| | (unit: gram) | | (unit: gram) | | solution |
| | c | f | c | i | (unit: cps) |
| b1 | 150 | 300 | 300 | 0.06 | 8800 |
| b2 | 150 | 300 | 300 | 0.08 | 17000 |
| b3 | 150 | 300 | 50 | 0.03 | 47500 |
| b4 | 200 | 300 | 200 | 0.05 | 6200 |
| b5 | 200 | 300 | 250 | 0.05 | 4250 |
| b6 | 200 | 300 | 300 | 0.05 | 2450 |
| b7 | 200 | 300 | 300 | 0.06 | 3900 |
| b8 | 100 | 300 | 300 | 0.06 | 44000 |
| b9 | 450 | 900 | 150 | 0.09 | 24650 |
| b10 | 600 | 1200 | 200 | 0.12 | 71000 |
| b11 | 700 | 1200 | 100 | 0.06 | 163000 |
| b12 | 1100 | 800 | 100 | 0.06 | 30000 |

According to examples b1 to b3, it may be concluded that viscosity of the combined solution would be greater with higher concentration of the thermal initiator (component i). Similarly, according to examples b4 to b7, it may be concluded that viscosity of the combined solution would be greater with higher concentration of the thermal initiator even the total amount of the thermal initiator are the same. According to examples b1, b7 and b8, it may be concluded that viscosity of the combined solution would be greater with less amount (or concentration) of the monomer (component c) in the reactor. According examples b10 and b11, it may be concluded that with the same total amount of monomer, total 800 g in both examples b10 and b11, viscosity of the combined solution would be greater when a higher proportion of monomer is firstly disposed in the reactor.

### Examples c1-c4

Examples c1 to c4 are another group of examples comprising multiple monomers involved in the polymerization reaction.

Examples c1 to c4 may be carried out following the steps (1), step (2) and step (3) aforesaid, but differently, the amount and proportion of the components comprised in the first solutions and the second solutions are as set forth in table 3. Viscosities of the resulting combined solutions of examples c1 to c4 are measured and also shown in table 3 accordingly.

TABLE 3

| | | | | | | | | | | | Viscosity |
|---|---|---|---|---|---|---|---|---|---|---|---|
| | | | | | | | | | | | of |
| | | | | | | | | | | | combined |
| | | | | | | | Components of the | | | | solution |
| | Components of the first solution | | | | | | second solution | | | | (unit: |
| | a | b | c | d | f | g | a | b | c | i | cps) |
| c1 | 100 | 100 | | 250 | | | 25 | 25 | | 0.1 | 7100 |
| c2 | 100 | 100 | | | 250 | | 25 | 25 | | 0.1 | 5500 |
| c3 | 100 | 100 | | | | 250 | 25 | 25 | | 0.1 | 8800 |
| c4 | 50 | 50 | 100 | 250 | | | 25 | 25 | 50 | 0.1 | 19400 |

According to examples c1 to c3, it may be concluded that the method of the present invention is applicable to compositions comprising different plasticizers (component d, f or g) to obtain the combined solution according to the present invention. According to examples a1 in previous group and c1 and c4, it may be concluded that method of the present invention is applicable to compositions comprising single, two or three monomers to obtain the combined solution according to the present invention.

One of the applications of the solvent-free thermal polymerization method according to the present invention is to prepare the LOCA used in optical devices and its corresponding frame glue with different viscosity respectively using the same raw material. The method according to the present invention may be able to obtain the LOCA and its corresponding frame glue in simplified steps in comparison with the conventional method. Moreover, the obtain LOCA and frame glue according to the present invention are highly compatible with each other and have similar optical characteristics, such as similar refraction index. The method according to the present invention uses monomer as starting material, which is cheaper and therefore has better cost efficiency than the conventional method using oligomer as starting material.

Advantageously, the solvent-free thermal polymerization method of the present invention not only has simplified process steps and lower cost, but also may be able to provide reaction products in a wide range of viscosity for various applications, such as adhering, coating or sealing, by simply adjusting the reacting time or the amount and proportion of constitutes of the compositions.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A thermally polymerizable composition comprising:
(a) a monomer;
(b) a thermal initiator; and
(c) a plasticizer,
wherein the monomer comprises a mono-functional acrylate monomer, a multi-functional acrylate monomer, or a mixture thereof.

2. The thermally polymerizable composition according to claim 1, wherein the boiling point of the plasticizer of the component (c) is at a temperature higher than the activating temperature of the thermal initiator of the component (b).

3. The thermally polymerizable composition according to claim 1, wherein the plasticizer of the component (c) is present in an amount not less than 30% by weight based on the total weight of the thermally polymerizable composition.

4. The thermally polymerizable composition according to claim 1, wherein the plasticizer of the component (c) is selected from a group comprising phthalic acid ester, aliphatic binary acid ester, phosphate ester, benzene polycarboxylic acid ester, fluorene-containing diester, alkyl sulfonic ester, polyol ester, epoxide, and a mixture thereof.

5. The thermally polymerizable composition according to claim 4, wherein the phosphate ester is selected from a group comprising triphenyl phosphate, tricresyl phosphate, tri(isopropylphenyl) phosphate, cresyl diphenyl phosphate, tetraphenyl resorcinol diphosphate, tetraphenyl 4,4′-(propane-2,2-diyl)bis(4,1-phenylene) diphosphate, and the mixture thereof.

6. The thermally polymerizable composition according to claim 1, wherein the thermal initiator is selected from a group comprising benzoyl peroxide, cumyl hydroperoxide, dicumyl peroxide, tert-Butyl hydroperoxide, tert-Butyl monoperoxymaleate, acetyl peroxide, dilauroyl peroxide, AIBN, and a mixture thereof.

7. The thermally polymerizable composition according to claim 1, wherein the monomer of the component (a) further comprises a vinyl monomer with a restriction of not including an acrylate monomer.

8. A combined solution formed from the thermally polymerizable composition as claimed in claim 1 via a method of solvent-free thermal polymerization.

9. The combined solution as claimed in claim 8, wherein the method of solvent-free thermal polymerization comprises:
(1) providing a first solution by mixing the monomer and the plasticizer in a reactor and heating the mixture to a pre-determined temperature, wherein the step (1) is carried out in a deoxygenated environment;
(2) mixing the first solution and the thermal initiator comprised in a second solution in the reactor in a deoxygenated environment to form the thermally polymerizable composition, wherein the second solution is supplied into the reactor in a drop-by drop manner; and
(3) initiating a thermal polymerization of the thermally polymerizable composition by the thermal initiator and the combined solution is obtained therefrom.

10. An adhering composition comprising the combined solution as claimed in claim 8.
